(19) United States
(12) Patent Application Publication
(10) Pub. No.: US 2006/0039286 A1
(43) Pub. Date: Feb. 23, 2006

(54) Method and apparatus for dynamically reducing end-to-end delay in multi-hop wireless networks in response to changing traffic conditions

(76) Inventors: Anindya Basu, East Windsor, NJ (US); Brian Boshes, Berkeley, CA (US); Sayandev Mukherjee, Plainsboro, NJ (US); Sharad Ramanathan, Springfield, NJ (US)

Correspondence Address: Lucent Technologies Inc.;Docket Administrator -Room 3J-219, 101, Crawfords Corner Road, Holmdel, NJ, 07733-3030, US

(21) Appl. No.: 10/920,750

(22) Filed: Aug. 18, 2004

(51) Int. Cl. H04J 3/14; H04L 12/26

(52) U.S. Cl. 370/238

(57) ABSTRACT

A method and apparatus for deforming the network topology of a multi-hop wireless network dynamically (i.e., in real time), in response to changing network traffic conditions and in order to advantageously reduce mean end-to-end network (transmission) delay. Two illustrative embodiments of the invention deform the network topology dynamically in response to traffic conditions (i) by changing the network connectivity between the existing network nodes and (ii) by adding one or more new nodes (and associated connections thereto and therefrom) to the network. In both cases, the traffic conditions may be fed into the algorithm in real time as, for example, a set of queue length measurements. Then, in response, the network is advantageously reorganized into a configuration that reduces the mean end-to-end network transmission delay.

### FIELD OF THE INVENTION

The present invention relates generally to wireless communications networks and more particularly to a method and apparatus for dynamically reducing transmission delays in multi-hop wireless networks in response to changing traffic conditions by changing network topology.

### BACKGROUND OF THE INVENTION

Recent developments in wide-area wireless technologies (such as, for example, the well known IEEE 802.16 standard) have led to considerable interest in the construction of multi-hop wireless mesh networks. In particular, such networks are being proposed and studied as an enabling technology for multiple applications such as machine-to-machine (M2M) communications, sensor networks, and Internet access for consumers and businesses, among others.

The standard architecture for such wireless mesh networks involves routing packets over multiple wireless hops until they reach the destination or a wired network core. The intermediate nodes may be mobile, static, or quasi-static (i.e., movable, but nonetheless stationary most of the time). For example, for the wireless Internet access scenario, a possible architecture would be a network of static or quasi-static wireless routers that aggregate incoming traffic from consumers (for example, from within a “pico-cell”). The aggregated traffic is then routed over the wireless mesh to a wired router connected to the Internet.

Most of the prior art approaches to the design and operation of these communications networks design a communications network in advance and are then “stuck with” the given network design. Although some such networks are in fact deigned based on certain a priori knowledge of the expected or “typical” traffic conditions (i.e., based on an a priori known “traffic matrix”), they are nonetheless fixed once designed. That is, given the fixed network, traffic is either routed through the network based on a predefined algorithm (e.g., the shortest path from source to destination), or, at best, is advantageously routed dynamically based on the network traffic existing at the given time. These approaches, however, cannot overcome the problems that result from inherent network “bottlenecks” in which a significant amount of traffic flows through a limited section of the network. Moreover, the location of these “bottlenecks” might change dynamically depending on changing traffic patterns and network demands.

### SUMMARY OF THE INVENTION

An interesting feature of multi-hop wireless networks is the added flexibility they provide in terms of network topology. Specifically, we have realized that the actual network topology of a multi-hop wireless network may be advantageously “deformed” (i.e., modified) in direct response to the network traffic that exists at a given point in time. For example, nodes may be advantageously moved relative to one another, the transmit power of a node may be increased (thereby, for example, bringing it within transmission range of one or more other nodes not previously within such range), or additional nodes may be added to the network. Each of these real-time network “deformations” may advantageously be employed to relieve temporary congestion in the network.

More particularly, in accordance with the principles of the present invention, a method and apparatus is provided for deforming the network topology of a multi-hop wireless network dynamically (i.e., in real time), in response to changing network traffic conditions and in order to advantageously reduce mean end-to-end network (transmission) delay. More specifically, two illustrative embodiments deform the network topology dynamically in response to traffic conditions (i) by changing the network connectivity between the existing network nodes and (ii) by adding one or more new nodes (and associated connections thereto and therefrom) to the network.

Both of these illustrative embodiments of the present invention are advantageously centralized, assume that the initial network topology is known, and use traffic-related information to advantageously modify the network topology in incremental steps. Advantageously, the traffic conditions may be fed into the algorithm of the present invention in real time as, for example, a set of queue length measurements. Then, in response, the network is advantageously reorganized into a configuration that reduces the mean end-to-end network transmission delay.

### BRIEF DESCRIPTION OF THE DRAWINGS

FIG. 1 shows an abstract view of an illustrative wireless communications network in which a “funneling” effect occurs at a bottleneck.

FIG. 2 shows a flowchart of one method for dynamically reducing transmission delays in multi-hop wireless networks in response to changing traffic conditions in accordance with a first illustrative embodiment of the present invention.

FIG. 3 shows a sample of a network deformation which results from the application of the illustrative method shown in FIG. 2; FIG. 3A shows the sample network before the deformation and FIG. 3B shows the sample network after the deformation.

FIG. 4 shows a flowchart of another method for dynamically reducing transmission delays in multi-hop wireless networks in response to changing traffic conditions in accordance with a second illustrative embodiment of the present invention.

FIG. 5 shows a sample of a network deformation which results from the application of the illustrative method shown in FIG. 4.

### DETAILED DESCRIPTION

Introduction and Summary

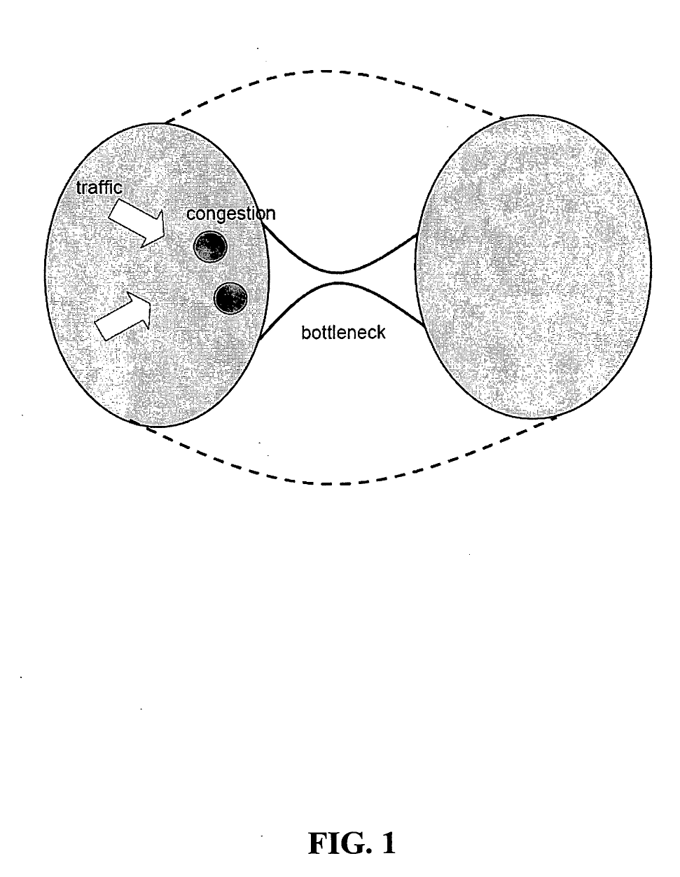

FIG. 1 shows an abstract view of an illustrative wireless communications network in which a “funneling” effect occurs at a bottleneck. As can be seen in the figure, traffic going across the bottleneck from the left half of the network to the right half of the network has to “squeeze” through links upstream of the bottleneck. This can cause congestion elsewhere in the network (as shown by the darker patches in the figure) even though the bottleneck bandwidth may be high. In accordance with the principles of the present invention, the solution to this problem is to siphon the traffic out early by creating new links (as shown by the dotted lines in the figure) that join network nodes away from the bottleneck link.

In order to describe the illustrative embodiments of the present invention, we will first derive a quickly computable metric that we note correlates well with the mean network transit time. Then, in accordance with certain illustrative embodiments of the present invention, we describe two network deformation algorithms which advantageously reduce this metric. In particular, we will first show herein how the mean end-to-end network delay correlates highly with the longest relaxation time of a stochastic matrix. We will refer to this as the “characteristic timescale” of the network. In particular, the characteristic timescale is a function of the network topology as well as the traffic load on the network, and can be easily computed analytically.

We will then describe two illustrative embodiments of the present invention (i.e., two algorithms) in detail, each of which changes the network topology in a manner that advantageously reduces the characteristic timescale of the network at each step. In particular, the first such algorithm for network deformation (i.e., the first described illustrative embodiment of the invention) assumes that a non-empty subset of the wireless nodes is movable. For example, one possible scenario consistent with such an assumption is a multi-hop wireless network that backhauls wireless data from customer premises to a central wired core. Some of the wireless nodes can be quasi-static in the sense that they may be moved (by mounting them on a truck) but are usually stationary. Such quasi-static wireless routers (or base stations) are already available from various vendors. Note that similar situations exist in disaster recovery scenarios where a network may be set up from scratch using such wireless nodes. The key idea here is to advantageously configure the connections between these backhaul routers (by moving the quasi-static ones around) so as to reduce the mean end-to-end delay in the network.

In particular, the algorithm of the first illustrative embodiment of the present invention takes as input the network topology, the coordinates of the wireless nodes in the network, and the network load in the form of queue lengths on each wireless link. It then tries to change the network connectivity by moving the non-static network nodes in small steps. This is advantageously done such that at each step, the network remains connected, and the characteristic timescale goes down. As node pairs come within transmission range of each other, new links are established. At the same time, old links get broken as the end nodes move beyond transmission range. Additional constraints (discussed below) ensure that all the nodes do not simply come close enough to each other to form a completely connected network, which would reduce the range and the coverage of the network drastically. In fact, it can be shown that in most cases, the total number of links in the resultant deformed network is either lower or marginally more than that in the original network.

The second algorithm (in accordance with the second illustrative embodiment of the present invention) described herein is aimed at alleviating congestion in wireless networks by introducing an additional node into the network. The core idea here is to connect a new node to the existing network in a manner that advantageously distributes existing network load as evenly as possible. Using the existing topology and the queue length data, the algorithm computes the position of the new node and the set of neighboring nodes to which it should be advantageously connected. This is done such that the new network has a lower characteristic timescale, and therefore, lower mean end-to-end delay.

System Model

We model a multi-hop wireless mesh network as a directed connected graph G=(N,E). The set of nodes in the network is represented by the set of vertices N in G, and numbered 1, . . . , |N|. Similarly, the set of edges E corresponds to the set of links in the network, where the directed edge eᵢⱼ corresponds to a unidirectional link (i, j) between node i and node j. Note that the terms nodes (links) and vertices (edges) will be used interchangeably herein. We assume that each node i has a queue Qᵢ associated with it, whose maximum size is unbounded. (Strictly speaking, queues are associated with links, and as will be obvious to those skilled in the art, this model can be easily extended to take this into account.) By assuming that queue lengths are unbounded, we ensure that no packet drops occur. Hence, as the traffic load increases, the average queue length increases, and the goodput decreases. We define network breakdown as the point where the average queue length goes to infinity, and the network output goes to zero. A similar effect is observed for the network goodput if the maximum queue size is finite—in this case, the network goodput goes to zero because of packet drops. We use the “unbounded queue size” model since it makes the exposition simpler.

We make no specific assumptions about the traffic generation statistics at each node except that the traffic generation process, and the resulting queue length processes, are wide sense stationary (WSS) and have finite correlation times. This implies that the traffic generation process has a time independent mean and finite memory, i.e., the queue lengths have well defined long time means and variances. We assume that the traffic demand matrix can vary rapidly or may be unknown. We also assume that the network carries a single traffic class. Lastly, we use a discrete time model for the system where events happen at discrete time steps.

We assume that each node in the network is capable of both transmitting and receiving at the same time. This is indeed possible in present generation wireless systems using frequency division duplexing (FDD).

In wireless networks, the link connection strengths may vary due to fading and node mobility. Therefore, an edge between node i and node j implies that the link strength is enough to transmit a bit from node i and decode it correctly at node j with at least some chosen probability. The edges are directed since it may be possible to transmit from node i to node j but not vice-versa. A neighbor of node i is any node j such that there is an edge eᵢⱼεE. We assume that the set of neighbors of node i is represented by nbr(i).

The capacity of a link from node i to node j is denoted by Cᵢⱼ and is given by Shannon's formula:

$${C}_{ij} = {C}_{0} {log}_{2} ( 1 + \frac{{S}_{ij}}{{I}_{j}} ) \qquad ( 1 )$$

where Sᵢⱼ is the signal power at node j received from node i, Iⱼ is the (interference-plus-) noise power at node j, and C₀ is a suitable normalization constant. Using equation (1), the connectivity requirement stated earlier translates to the following condition. We say that node i is connected to node j if and only if the signal strength at node j from node i is higher than the minimum signal strength required to decode signals correctly. In other words, a wireless link exists from node i to node j if and only if the channel capacity from node i to node j is greater than a given threshold. In such a case, we say that node j is within the “transmission range” of node i.

Furthermore, the signal power Sᵢⱼ is given by

$${S}_{ij} = \frac{{P}_{i}}{{d}_{ij}^{γ}} \qquad ( 2 )$$

where Pᵢ is the transmit power at node i, dᵢⱼ is the distance between node i and node j, and γ is the distance-loss exponent. Experimental measurements have shown the value of γ to be typically between 3.5 and 4 for cellular wireless systems. Note that we do not consider power control, and assume that all the nodes transmit at the same power, i.e., Pᵢ=P for all i.

We assume that at any node i, the interference-plus-noise power is a constant, i.e.,
I₁=I₂= . . . =I_{|N|} (3)
This implies that the total interference power received at any node from all other simultaneously transmitting nodes is the same. This quantity can be added to the thermal noise power, which is also assumed to be the same at every node. Such an assumption is realistic in a network employing a spread-spectrum air-interface (such as, for example, CDMA). In such a network, if each node uses the same amount of spreading and has a moderate number of interferers, and the distribution of interferers is approximately the same around any node in the network, then the total interference at any node can be modeled by a Gaussian random variable with variance (i.e., interference power) approximately constant. Since these assumptions are fairly realistic for today's networks, for purposes herein, we will assume that they hold. (Note that it is possible to relax these assumptions, but that requires adaptive power control, which we do not address herein.) Using equations (1) and (3), and the assumption that the transmit power at each node i is the same, we see that Cᵢⱼ=Cⱼᵢ for all i≠j. In other words, we can assume that all the edges in the graph G are symmetric in terms of capacity. This also implies that for any two nodes i and j, iεnbr(j) if and only if j ε nbr(i).

Furthermore, we assume that there are sufficiently many orthogonal codes that enable each node i to simultaneously transmit to each of its neighbors without interference. Most often, a typical node in a multi-hop mesh wireless network will have at most 10 neighbors. This translates to a maximum degree Δ of 10. Since Shannon's theorem (well known to those skilled in the art) states that the upper bound on the chromatic index of a graph is ( 3/2)Δ, it gives us a chromatic index of at most 15 for the network graphs that we will consider herein. This is the minimum number of orthogonal codes required to ensure interference-free transmissions. Since current CDMA systems like HDR (familiar to those skilled in the art) allow 16 orthogonal codes per user, and all the codes are different from one user to another, it is reasonable to expect that in a practical system there will be enough codes available to satisfy the above condition. When the network topology (connectivity) is changed by one of the illustrative deformation algorithms described below, the new code assignments can also be computed for the deformed topology such that the system always remains interference-free.

We assume that the nodes are sufficiently slow-moving that fast fading may be ignored. Given the source and destination node locations, the shadow fading is fixed, and therefore the connection strength between two nodes given by equation (1) is a function only of the transmit power and the distance between the nodes.

Packets at a node are scheduled on a First-in-First-out (FIFO) basis. Our earlier assumptions regarding interference imply that there is no explicit channel scheduling required to ensure interference-free transmission. As explained above, we assume that there are enough orthogonal codes available that simultaneous transmission from a node to all its neighbors (or reception by a node from all its neighbors) is possible without interference.

In order to derive the characteristic timescales analytically, we model routing as a diffusion-like process with some nonlinearities. The non-linearities are introduced by the probability that a packet remains enqueued at a node once it has arrived there. As we shall see below, these probabilities depend on the queue lengths at the different nodes, resulting in effective packet interactions. It can be argued that approximating routing by a diffusion-like process may not closely model reality. However, we point out that experimental evidence using shortest path routing suggest that our theoretical framework that models routing as a diffusion-like process predicts network behavior accurately.

Characteristic Timescales

Following the diffusion-like routing model, we say that a packet n (going from source s to destination d) at node j at time t leaves j at time t+1 with a probability (1−θⱼₙ^{sd}) and proceeds to a neighbor i of j with probability proportional to the capacity Cⱼᵢ of the link between j and i. The initial condition is that the packet n has probability 1 of being found at its source at the time it was created. When a packet n reaches its destination d, it stays there forever—we model this by assigning θⱼₙ^{sd}=1. The term θⱼₙ^{sd} represents the probability that packet n going from source s to destination d remains enqueued at node i at the next time step. We refer to this as the “staying probability” at node i. The staying probability depends on the queue length at node i and thus incorporates the effects of network traffic and packet interaction at the queues. We assume that the staying probability of a packet n at node i is independent of n, s, and d and denote it by θᵢ (except for θⱼₙ^{sd} which equals unity). This follows from our assumption that all packets are treated as equal (no priorities). In addition, note that the term θᵢ also depends on the time t, since the queue length (which determines θᵢ) varies over time. We have not shown this dependence explicitly for reasons that will become clear below.

We now consider all the packets with the same destination d and define the queue length variable Q_{d}(i,t) to be the probability that there is a packet intended for destination node d in the queue at node i at time t. Then the variable Q_{d}(i,t) satisfies

$${Q}_{d} ( i , t + 1 ) = {Q}_{d} ( i , t ) {θ}_{i} + {\sum }_{j ∈ nbr ( i )} \frac{{θ}_{j}}{{ℨ}_{ij}} {Q}_{d} ( j , t ) + {f}_{i}^{d} ( t ) \qquad ( 4 )$$

where ƒᵢ^{d}(t) is the probability that a packet generated at node i with destination d gets added to the queue at i at time t, and

$$\begin{matrix}{ℨ}_{ij} = \{ \begin{matrix}\frac{{C}_{j}}{{C}_{ji}} , & if i is connected to j , \\ ∞ , & otherwise , \end{matrix} & ( 5 ) \\ {C}_{j} = \begin{matrix}{\sum }_{i ∈ nbr ( j )} {C}_{ji} , & j = 1 , 2 , … , \vert N \vert .\end{matrix} & ( 6 )\end{matrix}$$

Note that equation (4) holds independent of the network load. Next, we define the normalized queue variable at a node i to be

$${p}_{i} ( t ) = [ {\sum }_{j ∈ N} {Q}_{j} ( i , t ) - {Q}_{i} ( i , t ) ] / {C}_{i} . \qquad ( 7 )$$

The expression above is the sum over all the packets at node i at time t that are destined for nodes other than i. This is because packets destined for node i have already reached their destination and are not part of the queue at i. Summing over all nodes d in equation (4), and using equation (7) and the fact that θᵢ=1 for all packets with destination i at node i, we see that the evolution of pᵢ(t) in time is described by:

$${p}_{i} ( t + 1 ) = {p}_{i} ( t ) {θ}_{i} + {\sum }_{i ∈ nbr ( i )} \frac{1 - {θ}_{j}}{{ℨ}_{ij}} {p}_{j} ( t ) + {W}_{i} ( t ) , \qquad ( 8 )$$

where the noise term

$${W}_{i} ( t ) = [ {\sum }_{d} {f}_{i}^{d} ( t ) + ( {Q}_{i} ( i , t ) - {Q}_{i} ( i , t + 1 ) ) ] / {C}_{i} \qquad ( 9 )$$

is the (normalized) sum of Σ_{d}ƒᵢ^{d} (t), the packet generation probability at node i at time t, and Qᵢ(i,t)−Qᵢ(i,t+1), which arises because of packets reaching their destination i and exiting the network. Then equation (8) can be rewritten as
p(t+1)=Mp(t)+W(t) (10)
where p(t), W(t) are |N|-dimensional column vectors with elements pᵢ(t), Wᵢ(t), respectively, and the |N|×|N| matrix M has entries

$${M}_{ij} = \{ \begin{matrix}{θ}_{j} , & if i = j , \\ \frac{1 - {θ}_{j}}{{ℨ}_{ij}} , & if i \neq j .\end{matrix} \qquad ( 11 )$$

We observe that the matrix M has non-negative elements and its columns add up to one. Since the network represented by the graph G is connected, we see from equation (10) that M represents the transition probability matrix of a Markov process that is aperiodic and irreducible. Therefore, it can be shown that the |N| eigenvalues of M are real and satisfy the property
1=|λ⁽¹⁾|>|λ⁽²⁾|≧ . . . ≧|λ^{(|N|)}| (12)
The corresponding left and right eigenvectors are represented by the row vector u⁽ⁱ⁾ and the column vector v⁽ⁱ⁾, respectively, i=1, . . . , |N|. Note that u⁽¹⁾ is the row vector [11 . . . 1], and v⁽¹⁾ is the stationary probability distribution of the Markov chain with transition probability matrix M.

Observe that if we take averages over long enough periods of time such that transient effects (or queue length fluctuations) die away, we get
\overline{p}=M\overline{p}+\overline{W}, (13)
where the bars denote long time averages. Defining the fluctuations of these quantities around the mean:
δp(t)=p(t)−\overline{p},δW(t)=W(t)−\overline{W}, (14)
we have
δp(t+1)=Mδp(t)+δW(t). (15)

We then examine the timescales over which the queue length fluctuations are correlated. By doing so, we can identify the longest timescale T_{c} after which the correlation in the queue length fluctuations (i.e., the variables δp(t)) die out rapidly. This means that the timescale T_{c} corresponds to the characteristic timescale of the network. To compute these timescales, we decompose the fluctuations δp(t) in terms of the eigenvectors of the matrix M as

$$δ p ( t ) = {\sum }_{i} δ {p}_{i} ( t ) \qquad ( 16 )$$

where δpᵢ(t) is the contribution due to the i'th eigenvector of M. Substituting the expression in equation (16) into equation (15), and left multiplying by u⁽ⁱ⁾ on both sides, we can show that

$$δ {p}_{i} ( t ) = {\sum }_{{t}^{′} < t} {ⅇ}^{( t - {t}^{′} ) ln \vert {λ}^{( i )} \vert} {u}^{( i )} W ( {t}^{′} ) {𝓋}^{( i )} . \qquad ( 17 )$$

Now consider a traffic fluctuation δW(t) that occurs at time t. This will result in fluctuations in the queue lengths (represented by δp(t), and its modes δpᵢ(t)). The timescale over which the fluctuation δpᵢ(t) occurs is given by

$$- \frac{1}{ln \vert {λ}^{( i )} \vert} .$$

Beyond this timescale, the fluctuation decays to a fraction 1/e of its original value and vanishes rapidly. Note that it is possible to choose a longer timescale as the characteristic timescale, during which the fluctuation decays to a smaller fraction 1/(e^{c}) (c>1, constant) of its original value. This simply makes the resulting timescale a constant multiple of the value that we have calculated.

Note that a change in δp₁(t) corresponding to the first (largest) eigenvalue changes the mean traffic level and is equivalent to operating at a higher load. Thus, without loss of generality, we set δp₁(t)=0.

Hence, from the above analysis, we deduce that the longest relaxation timescale corresponds to the δp₂(t) mode that is associated with the second largest eigenvalue, |λ⁽²⁾|. The related relaxation timescale is given by

$${T}_{c} = - \frac{1}{ln \vert {λ}^{( 2 )} \vert} \qquad ( 18 )$$

which is the characteristic timescale of the network.

The quantities θᵢ can be computed as follows. We assume that once a packet is added to a queue at node i at time t, the number of time slots taken by the packet to leave is the normalized queue length pᵢ(t). After that time, the probability of the packet remaining at node i becomes small, say, 1/e. Thus, the value of θᵢ can be set by requiring that

$${θ}_{i}^{{p}_{i} ( t )} = \frac{1}{e} \qquad ( 19 )$$

It can be shown that the value of θᵢ can be approximated using the long term average of the queue length variables \overline{p}ᵢ as

$${θ}_{i} = exp ( - \frac{1}{{\overline{p}}_{i}} ) \qquad ( 20 )$$

It follows from equation (18) that the fluctuations of the queue lengths about their mean value \overline{p}ᵢ become uncorrelated over a timescale proportional to

$$\frac{1}{\vert ln \vert {λ}^{( 2 )} ‖} ,$$

where λ⁽²⁾ is the eigenvalue of the matrix M with the second largest modulus. (Hereinafter, we will loosely refer to this eigenvalue as the “second largest eigenvalue” for the stochastic transition matrix.) This characteristic timescale depends on the network topology and the network load (as measured by the queue lengths), but is independent of the traffic generation statistics at the nodes. Simulations with ns have shown that this characteristic timescale strongly correlates with the mean end-to-end network delay, particularly as the network load increases. Furthermore, the mean end-to-end network delay diverges (or goes to infinity) continuously with the network load.

These results together suggest the following. First, it is possible to reduce the mean end-to-end delay in a network by deforming the network topology such that the characteristic timescale is reduced. In other words, a network deformation algorithm in accordance with an illustrative embodiment of the present invention which reduces the value of the parameter λ⁽²⁾ will also advantageously reduce the mean end-to-end delay in the network. Second, the continuous divergence of the mean end-to-end network delay suggests that if the network deformation algorithm is applied using queue length data at a specific network load l, it is likely that the deformed network will also exhibit reduced end-to-end delays at other network loads in the neighborhood of l. In accordance with the principles of the present invention, we now present two illustrative embodiments thereof, each of which advantageously leverages these observations to produce network deformations that lower the mean end-to-end delay.

A First Illustrative Embodiment of the Invention—the CD Algorithm

In accordance with a first illustrative embodiment of the present invention, the “CD” (continuous deformation) algorithm takes as input the network topology and the queue length data at each link under current traffic conditions. It then computes how the network may be deformed “continuously” by moving the non-static nodes such that the characteristic timescale of the new network goes down, thereby reducing the mean end-to-end delay.

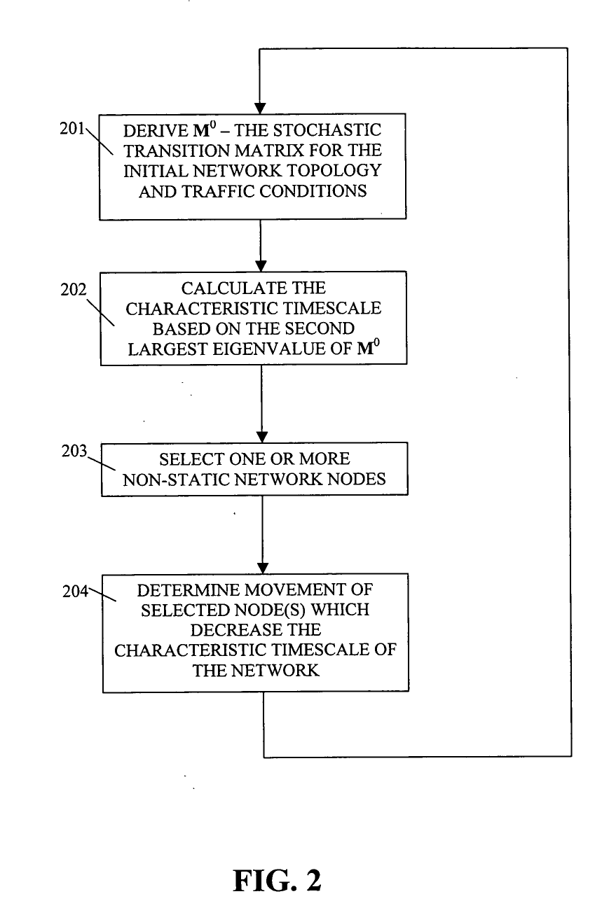

FIG. 2 shows a flowchart of one method for dynamically reducing transmission delays in multi-hop wireless networks in response to changing traffic conditions in accordance with a first illustrative embodiment of the present invention. In block 201, we derive M⁰, the stochastic transition matrix for the initial network topology and the initial traffic conditions (i.e., the queue length data). Then, in block 202, we calculate the “characteristic timescale” based on the second largest eigenvalue of M⁰.

In block 203, we select one or more movable (i.e., non-static) nodes in the network, and finally, in block 204, we determine physical movements of the selected node(s) which result in a decrease of the value of the characteristic timescale. In other words, we modify the network by moving one or more non-static nodes such that one or more network links are added and/or removed (as a result of changes in the distances between nodes), and we do so in such a way that when the characteristic timescale is re-calculated, it has decreased. In this manner, we have advantageously deformed the network in such a way so as to reduce the end-to-end delay. Then, if desired, we repeat the process.

We will now describe the CD algorithm in detail. Assume that the initial network is represented by the graph G⁰=(N⁰, E⁰). Let the corresponding stochastic transition matrix be M⁰, as defined in equation (11). Note that this matrix is computed using the queue length data from the initial network, and therefore incorporates traffic information. Let the i'th left and right eigenvectors be u₀⁽ⁱ⁾ and v₀⁽ⁱ⁾, respectively, with the eigenvalue λ₀^{(i )}. The left and right eigenvectors are normalized such that u₀⁽ⁱ⁾·v₀⁽ⁱ⁾=1. Note that u₀⁽ⁱ⁾·v₀⁽ⁱ⁾=0, ∀i≠j. The initial node locations are represented by the set r⁰={r₁⁰,r₂⁰,K ,r_{|N}_{⁰}_{|}⁰}, where rᵢ⁰ is the two-dimensional position vector for node i.

Intuitively, it is clearly advantageous for our algorithm to decide which nodes to move closer, and which to move farther apart. This changes the capacities of the links between the moved nodes due to the changes in the received signal strength, as given by equation (2). Using capacity thresholds (as described above), we can then change the connectivity of the network. The decision on how to move these nodes should be based on the traffic conditions encapsulated in the matrix M⁰. Furthermore, the net change in connectivity should be such that the second largest eigenvalue for the modified stochastic transition matrix M is lower (thereby reducing the mean end-to-end delay).

To understand the process, assume (for now) that all the network nodes are movable. We now imagine adding an infinitesimally small capacity εᵢⱼ between every pair of nodes i and j. If the imaginary increase in capacity between two specific nodes results in a decrease in the second largest eigenvalue, we would like to consider moving these nodes closer to each other. Now, as a result of this imaginary increase in capacity, we can write the modified stochastic transition matrix as
M=M⁰+M⁶⁸ (21)
We can compute the elements Mᵢⱼ^{ε} of the matrix M⁶⁸ to linear order in εᵢⱼ as follows. From equations (11) and (5), we know that

$${M}_{ij}^{0} = \{ \begin{matrix}{θ}_{j} , & if i = j , \\ \frac{{C}_{ji}^{0}}{{C}_{j}^{0}} ( 1 - {θ}_{j} ) , & if i \neq j\end{matrix} \qquad ( 22 )$$

where Cⱼᵢ⁰ is the capacity of the link (j, i) in the original network graph G⁰. We focus on the i≠j case since, by definition, Mᵢⱼ^{ε}=0 if i=j. Now let us compute the (i, j)'th element of the matrix M⁰+M^{ε}. Since the capacity of each link (i, j) has been incremented by εᵢⱼ, we can say that

$${M}_{ij} = {( {M}^{0} + {M}^{ε} )}_{ij} = \frac{{C}_{ji}^{0} + {ε}_{ji}}{{C}_{j}^{0} {\sum }_{k} {ε}_{jk}} ( 1 - {θ}_{j} ) \qquad ( 23 )$$

Using Taylor series expansions, and approximations to linear order in εᵢⱼ, we can rewrite equation (23) as

$$\begin{matrix}{( {M}^{0} + {M}^{ɛ} )}_{ij} = \frac{{C}_{ji}^{0} + {ε}_{ji}}{{C}_{j}^{0}} ( 1 - \frac{{\sum }_{k} {ε}_{jk}}{{C}_{j}^{0}} ) ( 1 - {θ}_{j} ) \\ \approx \frac{{C}_{ji}^{0}}{{C}_{j}^{0}} ( 1 - {θ}_{j} ) + \frac{1 - {θ}_{j}}{{C}_{j}^{0}} ( {ε}_{ji} - \frac{{C}_{ji}^{0} {\sum }_{k} {ε}_{jk}}{{C}_{j}^{0}} ) & ( 24 ) \\ = {M}_{ij}^{0} + \frac{1 - {θ}_{j}}{{C}_{j}^{0}} ( {ε}_{ji} - \frac{{C}_{j}^{0} {\sum }_{k} {ε}_{jk}}{{C}_{j}^{0}} ) & ( 25 )\end{matrix}$$

Therefore we can conclude that

$${M}_{ij}^{ε} = \{ \begin{matrix}0 , & if i = j , \\ \frac{1 - {θ}_{j}}{{C}_{j}^{0}} ( {ε}_{ji} - \frac{{C}_{ji}^{0} {\sum }_{k} {ε}_{jk}}{{C}_{j}^{0}} ) , & if i \neq j\end{matrix} \qquad ( 26 )$$

We now show how a change in the εᵢⱼ's changes the second largest eigenvalue of the stochastic transition matrix. From equation (21), we can compute this change to linear order in εᵢⱼ as follows. Let the second largest eigenvalue of the matrix M be λ⁽²⁾, and the associated left and right eigenvectors be u⁽²⁾, v⁽²⁾, respectively. We assume that the change in u₀⁽²⁾ due to the M^{ε} change in the matrix M⁰ is small, and a function of ε given by δu(ε). Thus from equation (21) we have
u⁽²⁾=u₀⁽²⁾+δu(ε) (27)
and similarly,
v⁽²⁾=v₀⁽²⁾+δv(ε) (28)
Now, using equations (21), (27) and (28), we have
λ⁽²⁾−λ₀⁽²⁾=u⁽²⁾Mv⁽²⁾−u₀⁽²⁾M⁰v₀⁽²⁾ (29)
To linear order in ε, the first term on the RHS can be rewritten as
u₀⁽²⁾+δu(ε))(M⁰+M^{ε})(v₀⁽²⁾+δv(ε))≈u₀⁽²⁾M⁰v₀⁽²⁾+u₀⁽²⁾M^{ε}v₀⁽²⁾+u₀⁽²⁾M⁰δv(ε)+δu(ε)M⁰v₀⁽²⁾ (30)
Consider the term u₀⁽²⁾M⁰δv(ε). Since the eigenvectors of M⁰ form a complete basis set, we can expand δv(ε) as

$$δ 𝓋 ( ε ) = {\sum }_{j \neq 2} δ {a}_{j} {𝓋}_{0}^{( j )} \qquad ( 31 )$$

where the δaⱼ's are scalar constants. Note that the term corresponding to j=2 is omitted because it simply results in scaling that is canceled by the normalization condition. Therefore we have

$${u}_{0}^{( 2 )} {M}^{0} δ𝓋 ( ε ) = {\sum }_{j \neq 2} δ {a}_{j} {u}_{0}^{( 2 )} {M}^{0} {𝓋}_{0}^{( j )} \qquad ( 32 )$$

Since the eigenvectors are mutually orthogonal, u₀⁽²⁾M⁰v₀^{(j)}=0, j≠2. Therefore the term u₀⁽²⁾M⁰δv(ε) (and similarly, the term δu(ε)M⁰v₀⁽²⁾) vanishes. Thus, we have
u⁽²⁾Mv⁽²⁾=u₀⁽²⁾M⁰v₀⁽²⁾+u₀⁽²⁾M^{ε}v₀⁽²⁾ (33)
which gives us
λ⁽²⁾−λ₀⁽²⁾=u₀⁽²⁾M^{ε}v₀⁽²⁾ (34)
that can be rewritten as

$${λ}^{( 2 )} - {λ}_{0}^{( 2 )} = {\sum }_{i} {\sum }_{j} {u}_{0 , i}^{( 2 )} {M}_{ij}^{ε} {υ}_{0 , j}^{( 2 )} \qquad ( 35 )$$

where u_{0,i}⁽²⁾, v_{0,j}⁽²⁾ are the i,j'th elements of u₀⁽²⁾, v₀⁽²⁾, respectively. From equations (26) and (35), it follows that we should choose the values of εᵢⱼ such that λ⁽²⁾<λ₀⁽²⁾.

Finally, we compute the changes in link capacities εᵢⱼ as a function of the node displacements about the initial position r⁰={r₁⁰,r₂⁰,K ,r⁰_{|N}_{⁰}_{|}⁰}. This enables us to compute the change in the second largest eigenvalue as a function of the node positions. Let the initial distance between node i and node j be dᵢⱼ⁰, the signal strength between the two nodes be Sᵢⱼ⁰ (as defined by equation (2)), and the capacity between them be Cᵢⱼ⁰ (as defined by equation (1)). Now consider moving the nodes in G⁰ by infinitesimal displacements in the neighborhood of r⁰. The new positions are represented by the variables r={r₁,r₂,K ,r_{|N}_{⁰}_{|}}. We can now compute (using first order approximations) the resulting change in capacity εᵢⱼ between nodes i and j as follows. By definition, we have
εᵢⱼ=Cᵢⱼ−Cᵢⱼ⁰ (36)
Now let δSᵢⱼ be the change in signal strength at node j due to node i after the infinitesimal displacements take place. Using equations (1) and (9), we can say that

$$\begin{matrix}{C}_{ij} = {C}_{0} log ( 1 + \frac{{S}_{ij}}{η} ) \\ = {C}_{0} log ( 1 + \frac{{S}_{ij}^{0} + δ {S}_{ij}}{η} ) \\ = {C}_{0} log ( ( 1 + \frac{{S}_{ij}}{η} ) ( 1 + \frac{δ {S}_{ij}}{η + {S}_{ij}^{0}} ) ) \\ = {C}_{ij}^{0} + {C}_{0} log ( 1 + \frac{δ {S}_{ij}}{η + {S}_{ij}^{0}} )\end{matrix} \qquad ( 37 )$$

Now, from equation (2), we have

$${δS}_{ij} = - \frac{γ {P}_{i}}{( {d}_{ij}^{0} ) γ + 1} δ {d}_{ij} = - \frac{γ {S}_{ij}^{0}}{{d}_{ij}^{0}} δ {d}_{ij} \qquad ( 38 )$$

where δdᵢⱼ is the change in the distance between node i and node j. Combining equations (36), (37) and (38), we have

$${ε}_{ij} = {C}_{0} log ( 1 - \frac{γ {S}_{ij}^{0} δ {d}_{ij}}{( η + {S}_{ij}^{0} ) {d}_{ij}^{0}} ) \qquad ( 39 )$$

Expanding the RHS of equation (39) using Taylor expansion, we can approximate εᵢⱼ to linear order in δdᵢⱼ as

$${ε}_{ij} \approx - \frac{{C}_{0} γ {S}_{ij}^{0}}{( η + {S}_{ij}^{0} ) {d}_{ij}^{0}} δ {d}_{ij} \qquad ( 40 )$$

We can now compute the change in the second eigenvalue of the stochastic matrix M as the nodes move (in the neighborhoods of their initial positions), using equations (40), (26), and (35). These equations collectively represent the matrix M as a function of the node position variables r={r₁,r₂,K ,r_{|N}^{₀}_{|}}, i.e., M=M(r). Note that the rᵢ's are variables denoting possible node positions in the neighborhood of the fixed initial node positions rᵢ⁰'s. We would like to move the nodes (i.e., change the position vectors r) in such a way that the second largest eigenvalue of the resulting matrix M(r) is reduced. In other words, we want to move each node in the direction that produces the maximum decrease in the second largest eigenvalue of the matrix M(r). This can be done as follows. We evaluate the gradient of the change in the second largest eigenvalue with respect to the node positions r. We then move each node i by a small amount from its initial position rᵢ⁰, in the direction of the steepest gradient. More formally, we can write a discrete evolution equation for each one of the node position vectors rᵢ⁰ as
rᵢ=rᵢ⁰−ζ∇ᵢλ⁽²⁾ (41)
Using equations (21) and (35), we can rewrite this as

$$\begin{matrix}r = {r}_{i}^{0} - ζ {∇}_{i} {u}_{0}^{( 2 )} M ( r ) {v}_{0}^{( 2 )} \\ = {r}_{i}^{0} - ζ {∇}_{i} {\sum }_{j , k}^{} {u}_{0 , j}^{( 2 )} {M}_{jk} ( r ) {υ}_{0 , k}^{( 2 )}\end{matrix} \qquad ( 42 )$$

Here, the gradient operator ∇ᵢ is with respect to the position vector rᵢ, and is evaluated at the initial node positions given by r⁰. Note that the gradient on the RHS can be calculated using equations (40) and (26). The constant ζ is the step size by which the nodes move, and is advantageously chosen to be small. We observe that according to this equation, node i advantageously moves in the direction of steepest descent by an amount proportional to the product of the stepsize ζ and the quantity

$${∇}_{i} {\sum }_{j , k}^{} {u}_{0 , j}^{( 2 )} {M}_{jk} {v}_{0 , k}^{( 2 )}$$

which we refer to herein as the “total force” acting on node i. Thus, from equation (42), we see that the nodes move in response to the properties of the matrix M which in turn depend both on the topology of the network and the traffic conditions.

Note that the algorithm as presented thus far allows unconstrained node movements. It may be possible that such node movements may result in a deformed network where all the nodes are arbitrarily close to each other, thereby significantly reducing coverage. Going to the other extreme, it is possible that some of the nodes separate and move far away from the main cluster, thereby disconnecting the network. To ensure that these situations do not occur, in accordance with one illustrative embodiment of the present invention, we advantageously make use of the following constraints.

First, there is a minimum threshold distance d₀ (given as a parameter) below which the inter-node distances are advantageously constrained not to go. Second, whenever any node is moved, the algorithm advantageously ensures that the network remains connected. It is also possible to limit the amount of deformation further by bounding the distance a node can move from its original position. In practice, we have found that the first two constraints are sufficient to produce “good” deformations.

We now come to the issue of obstacles in the terrain over which these wireless nodes are deployed. These obstacles could be trees, walls, buildings or other static objects that prevent the free movement of nodes. In accordance with one illustrative embodiment of the present invention, we advantageously take the obstacles into account as follows. When the steepest descent direction is computed, the algorithm checks to see if such a move would bring a node within a distance d₀ of any obstacle. If so, such a move is advantageously canceled. Finally, if only a subset of the nodes in the network are movable, the algorithm keeps the static nodes fixed in their initial position, and computes new positions only for the set of movable nodes. In accordance with one illustrative embodiment of the present invention, a somewhat simplified version of the CD algorithm may be employed. We begin by neglecting the term

$$\frac{{C}_{ji}^{0} {\sum }_{k} {ɛ}_{jk}}{{C}_{j}^{0}}$$

in equation (26). (Note for example, that in large networks, a typical node may be connected to many other nodes, making

$$\frac{{C}_{ji}^{0}}{{C}_{j}^{0}}$$

much less than 1 for all i and j. Given that both εⱼᵢ and

$${\sum }_{k} {ɛ}_{jk} O ( ɛ )$$

where ε=max_{i,j} ε_{i,j},

$$\frac{{C}_{ji}^{0} {\sum }_{k} {ɛ}_{jk}}{{C}_{j}^{0} {ɛ}_{jk}}$$

is much less than 1 for all i and j. Thus, the approximation can be used directly for such large networks.) Consequently, equation (42) can be simplified as

$${r}_{i} = {r}_{i}^{0} - ζ {∇}_{i} {\sum }_{j} {V}_{ij} ( {d}_{ij} ) \qquad ( 43 )$$

where the quantity Vᵢⱼ(dᵢⱼ) is given by (using equations (26) and (40))

$${V}_{ij} ( {d}_{ij} ) = \frac{{C}_{0} γ {S}_{ij}^{0}}{( η + {S}_{ij}^{0} ) {C}_{j}^{0}} \frac{ χ}{{d}_{ij}} \qquad ( 44 )$$

and χ is given by
χ=u_{0,j}⁽²⁾(1−θⱼ)v_{0,i}⁽²⁾+u_{0,i}⁽²⁾(1−θᵢ)v_{0,j}⁽²⁾ (45)
We can now rewrite equation (44) as

$${V}_{ij} ( {d}_{ij} ) = \frac{{C}_{0} γ {S}_{ij}^{0}}{( η + {S}_{ij}^{0} ) {C}_{j}^{0}} \frac{ Im ( {q}_{i}^{0} {q}_{j}^{0} ) }{{d}_{ij}} \qquad ( 46 )$$

where Im(x) denotes the imaginary part of the complex quantity x, and qᵢ⁰ is given by
qᵢ⁰=u_{0,i}⁽²⁾(1−θᵢ)+Iv_{0,i}⁽²⁾, I=\sqrt{−1} (47)
Note that the equations (43) and (46) are together analogous to Coulomb's law, where each node i has a “charge” qᵢ⁰ and a “potential” Vᵢⱼ(dᵢⱼ) due to node j. The charge assigned to each node depends on the network topology and the traffic conditions (through queue length measurements), and the nodes attract or repel each other through a potential inversely proportional to the distance between them. Note that it is also possible to write equation (42) in a similar form, but it would include some higher order correction terms. These correction terms arise when the term

$$\frac{{C}_{ji}^{0} {\sum }_{k} {ɛ}_{jk}}{{C}_{j}^{0}}$$

in equation (26) cannot be neglected, but the general form the equation remains the same as in equation (43). The key here is to observe that the node position vectors are governed by a “Coulomb-like” law with “charges” assigned to each node.

It can be shown that for any two nodes i and j that lie on opposite sides of a highly congested area (or bottleneck) in the network, Im(qᵢ⁰qⱼ⁰)<0, while for nodes on the same side of a bottleneck, Im(qᵢ⁰qⱼ⁰)>0. This means that the fluctuations in queue lengths at nodes that lie on opposite sides of a bottleneck are anti-correlated, while those for nodes on the same side of a bottleneck are correlated. More intuitively, we can think of the nodes on the same side of a bottleneck as trying to send packets across to the “other side” of the bottleneck. In contrast, the nodes on the opposite sides of a bottleneck can be thought of as a “source-destination” pair. During the execution of the algorithm, these “source-destination” pairs attract each other (product of charges is negative) to form new connections that relieve congestion. Nodes on the same side of a bottleneck repel each other (product of charges is positive). The links between such nodes are not crucial to the performance of the network (for the current traffic pattern) since most packets are being sent across the bottleneck and not among these nodes. Therefore, these nodes move farther away from each other, and the links between them are broken.

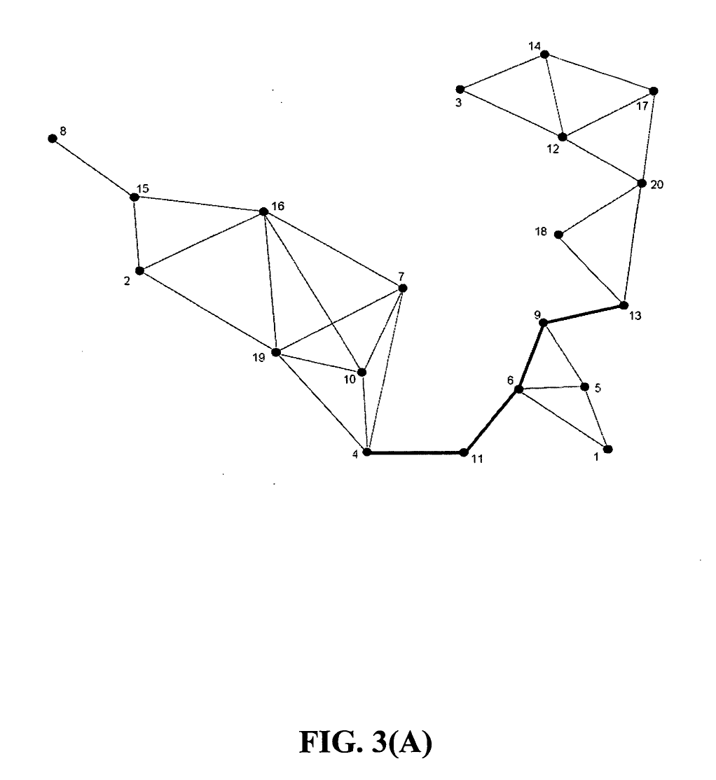

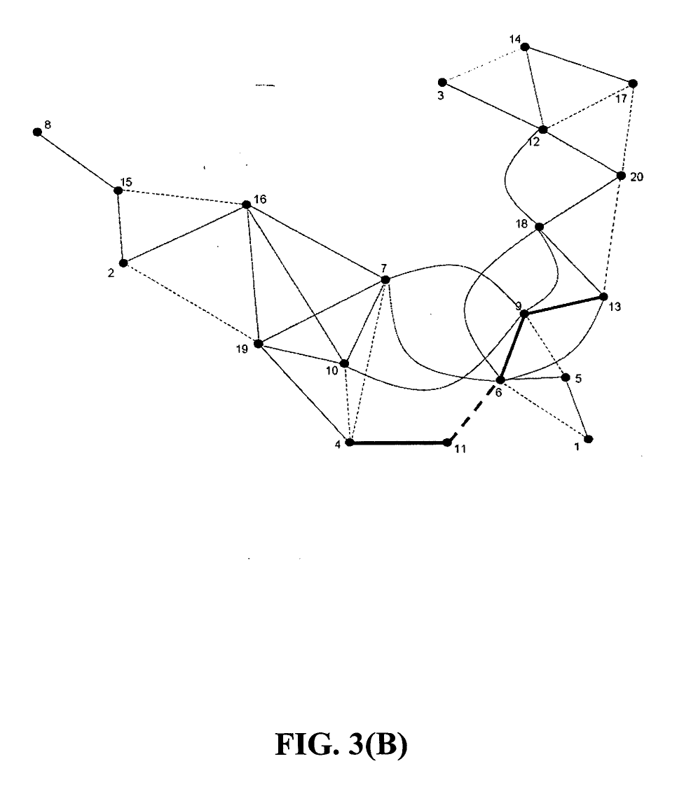

FIG. 3 shows a sample of a network deformation which results from the application of the illustrative method shown in FIG. 2 and described in detail above. FIG. 3A shows the sample network before the deformation and FIG. 3B shows the sample network after the deformation. The thick lines shown in FIG. 3A represent the bottleneck links. The dashed lines in FIG. 3B represent the links that have been eliminated and the curved lines in FIG. 3B represent the links that have been added.

A Second Illustrative Embodiment of the Invention—the DIPOLE Algorithm

In accordance with a second illustrative embodiment of the present invention, the DIPOLE algorithm connects a new node to the network at the “best possible” location such that the mean end-to-end delay is advantageously reduced. For example, this might be a node that moves in real time to relieve congestion wherever there is a traffic buildup.

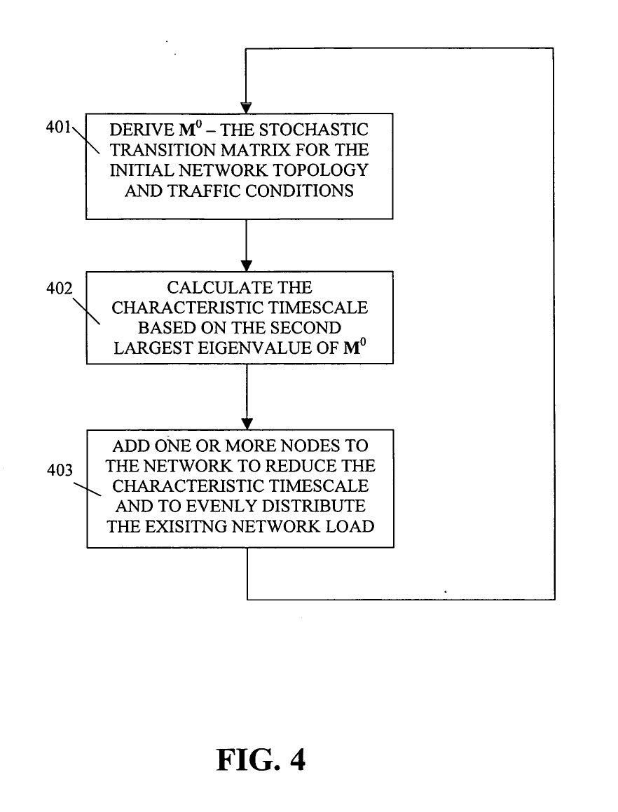

FIG. 4 shows a flowchart of this second illustrative method for dynamically reducing transmission delays in multi-hop wireless networks in response to changing traffic conditions. In block 401, we derive M⁰, the stochastic transition matrix for the initial network topology and the initial traffic conditions (i.e., the queue length data). Then, in block 402, we calculate the “characteristic timescale” based on the second largest eigenvalue of M⁰.

Finally, in block 403, we add one or more nodes to the network (and thereby add one or more network links connected thereto), which results in a decrease of the value of the characteristic timescale. In particular, we advantageously add such nodes in such a way so as to distribute the existing network load (i.e., traffic) as evenly as possible. In this manner, we have advantageously deformed the network in such a way so as to have substantially reduced the end-to-end delay. Then, if desired, we repeat the process.

The DIPOLE algorithm will now be described in detail using the “Coulomb's law” analogy discussed above in connection with the CD algorithm of the first illustrative embodiment of the invention. Recall that the CD algorithm works by adding new links between nodes i and j that have high negative values of the product Im(qᵢ⁰qⱼ⁰). In other words, the new links connect the “positively-charged” and “negatively-charged” clusters of the existing network. In the DIPOLE algorithm, a node will be advantageously added to the network in a way that mimics the effects of the new links in the CD algorithm. More specifically, we want the new node to be a “bridge” between the “positively-charged” and “negatively-charged” clusters of the existing network.

The key idea here is to assign a charge to the new node and let it move in the “potential field” induced by the “charges” on the existing network nodes. These movements are advantageously subject to the following constraints. First, the deformed network remains connected, and, second, no two nodes come within less than a distance d₀ of each other. The new node should finally come to rest at the position of least energy in its “potential field”. We would like to ensure that this position of least energy lies between the “oppositely charged” clusters such that the new node can form bridges between them.

The issue here is to determine the nature of the charge we should assign to the new node such that its behavior conforms to the requirements outlined in the previous paragraph. Clearly, assigning a single charge (of either sign) to the new node, and letting it move would be insufficient. In such a case, the new node would move as close as possible to the “oppositely charged” cluster and stay there. Therefore, we advantageously replace the single movable node by a dipole with opposite charges at each end. This ensures that the position of least energy for the new node lies between the “oppositely charged” clusters in the existing network.

The dipole charge on the new node can be simulated by replacing the single movable node with two nodes a small distance δ(<<d₀) apart. Let the positions of the two nodes d₁, d₂, be denoted by the position vectors r_{d}_{₁},r₂_{₂}, respectively. We assign to the first member of the dipole d, the “charge” q_{d}_{₁}=q_{d} (1+l), and to the second member of the dipole d₂ an equal and opposite charge q_{d}_{₂}=−q_{d} (1+l), where I=\sqrt{−1}. The quantity q_{d} can be advantageously chosen to be some small constant. Following equation (43), the dipole dynamics are now governed by the equations of motion

$$\begin{matrix}{r}_{{d}_{1}}^{′} = {r}_{{d}_{1}} - ζ {∇}_{{d}_{1}} {\sum }_{j} {V}_{{d}_{1} j} \\ and & ( 48 ) \\ {r}_{{d}_{2}}^{′} = {r}_{{d}_{2}} - ζ {∇}_{{d}_{2}} {\sum }_{j} {V}_{{d}_{2} j} & ( 49 )\end{matrix}$$

where the primes denote the new positions of the dipole nodes, and ζ is a small constant denoting the step size. The dipole moves subject to the following constraints. First, the dipole nodes are kept at a minimum distance δ apart at all times, and second, the network is kept connected at all times. In addition, no two nodes are permitted to come within less than distance d₀ of each other. The potentials with which the dipole node d₁ interacts with any node j (≠d₁) of the network is given by
V_{d}_{ᵢⱼ}(d_{d}_{₁ⱼ})=ƒ(d_{d}_{₁ⱼ})Im(q_{d}_{₁}qⱼ⁰) (50)
Similarly, the potential with which the dipole node d₂ interacts with any node j(≠d₁) of the network is given by
V_{d}_{₂ⱼ}(d₂_{₂ⱼ})=ƒ(d_{d}_{₂ⱼ})Im(q_{d}_{₂}qⱼ⁰) (51)
Here, the quantities d_{d}_{₁}ⱼ,d_{d}_{₂}ⱼ denote the distances of the dipole nodes d₁, d₂, respectively from node j, and the function ƒ(d) is a monotonically decreasing function of d. Note that the two dipole nodes do not interact with each other.

In accordance with one illustrative embodiment of the present invention, to find the minimum energy position for the dipole nodes more effectively we may advantageously implement the equations of motion in the following form

$$\begin{matrix}{V}_{{d}_{1} j} ( {d}_{{d}_{1} j} ) = f ( {d}_{{d}_{1} j} ) Im ( {q}_{{d}_{1}} {q}_{j}^{0} ) θ [ - Im ( {q}_{{d}_{1}} {q}_{j}^{0} ) ] \\ and & ( 52 ) \\ {V}_{{d}_{2} j} ( {d}_{{d}_{2} j} ) = f ( {d}_{{d}_{2} j} ) Im ( {q}_{{d}_{2}} {q}_{j}^{0} ) θ [ - Im ( {q}_{{d}_{2}} {q}_{j}^{0} ) ] \\ where & ( 53 ) \\ θ ( x ) = \{ \begin{matrix}1 , & if x > 0 , \\ 0 , & otherwise\end{matrix} & ( 54 )\end{matrix}$$

This advantageously ensures that each member of the dipole is attracted by the “oppositely charged” network nodes, but not repelled by those with the same “charge”. Thus, if the current position of the dipole is such that network clusters with “opposite charges” lie on the same side of the dipole, the modified equations of motion will “pull” the dipole towards a position that is in between the “oppositely charged” clusters. Without this modification, it is possible that the “repulsion forces” would push the dipole away from the preferred “central” position. This can happen, for example, if the “positively” charged dipole end is closer to a “positively” charged network cluster. Finally, we advantageously choose the function ƒ(d) to be of the form

$$f ( d ) = - log ( \frac{d}{{d}_{0}} ) .$$

In this way, the charges can “see” each other at larger do separations compared to the standard form ƒ(d)=1/d. Thus, the new node advantageously moves to the minimum energy position faster than it otherwise would.

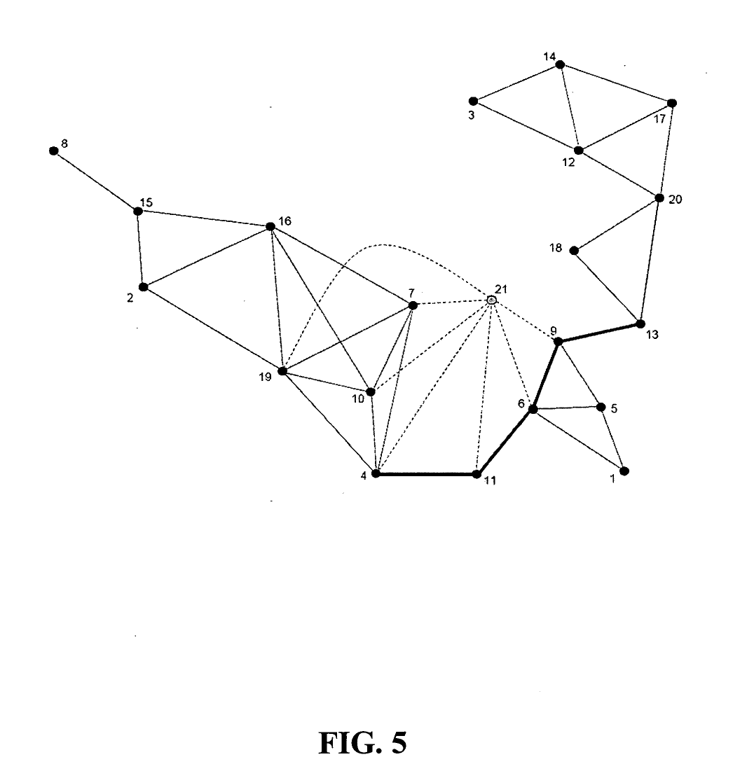

FIG. 5 shows a sample of a network deformation which results from the application of the illustrative method shown in FIG. 4 and described in detail above. The original network nodes are solid black and the original links are the solid lines. The bottleneck links are shown as thick lines. The new node (number 21) is shown in gray and the new links (i.e., those added by the method of FIG. 4) are shown in the figure as dotted lines.

Other Possible Illustrative Embodiments of the Present Invention

Note that the deformation algorithms described above attempt to reduce the characteristic timescale by changing link capacities, and node mobility or node addition (as shown in those illustrative embodiments) are only two possible ways to accomplish this. In accordance with other illustrative embodiments of the present invention, various alternative ways to modify network connectivity may be employed.

For example, one such way to modify network connectivity would be to change the transmit powers at the network nodes. Thus, in accordance with another illustrative embodiment of the present invention, an adaptive power control algorithm responds to changing traffic conditions by advantageously changing the transmission powers at the network nodes such that new links are established across the network bottlenecks.

Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. Furthermore, all examples and conditional language recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

Thus, for example, it will be appreciated by those skilled in the art that any flow charts, flow diagrams, state transition diagrams, pseudocode, and the like represent various processes which may be substantially represented in computer readable medium and so executed by a computer or processor, whether or not such computer or processor is explicitly shown. Thus, the blocks shown, for example, in such flowcharts may be understood as potentially representing physical elements, which may, for example, be expressed in the instant claims as means for specifying particular functions such as are described in the flowchart blocks. Moreover, such flowchart blocks may also be understood as representing physical signals or stored physical data, which may, for example, be comprised in such aforementioned computer readable medium such as disc or semiconductor storage devices.

We claim:

1. A method for reducing end-to-end delays in a multi-hop wireless network, the method comprising the steps of:
calculating, based on an initial physical network topology and on a set of parameters representing current traffic conditions in said multi-hop wireless network, a value of a metric which positively correlates to said end-to-end delays; and
modifying said initial physical network topology to generate a modified physical network topology which results in a reduced value of said metric when said metric is calculated based on said modified physical network topology and on said set of parameters representing current traffic conditions in said multi-hop wireless network.

2. The method of claim 1 wherein said initial physical network topology comprises a set of network nodes and a set of network links interconnecting pairs of said network nodes.

3. The method of claim 2 wherein said set of parameters representing current traffic conditions comprise queue lengths associated with said network links.

4. The method of claim 3 wherein said metric is computed based on an eigenvalue of a matrix M, wherein said matrix M is a stochastic transition probability matrix derived based on said queue lengths associated with said network links.

5. The method of claim 4 wherein said eigenvalue of said matrix M is a second largest eigenvalue of said matrix M.

6. The method of claim 2 wherein said step of modifying said initial physical network topology to generate a modified physical network topology comprises the step of modifying said set of network links by adding links thereto and/or removing links therefrom.

7. The method of claim 6 wherein one or more of said network nodes are non-static network nodes, and wherein said step of modifying said set of network links comprises moving one or more of said non-static network nodes in physical relation to one or more other network nodes, thereby modifying said set of network links as a result of changed distances therebetween.

8. The method of claim 7 wherein said moving of said one or more non-static nodes is constrained so as to limit said changed distances therebetween to a minimum value and to prevent said network from becoming disconnected.

9. The method of claim 6 wherein said step of modifying said set of network links comprises adding one or more nodes to said set of network nodes and adding one or more network links connected to said one or more added nodes to said set of network links as a result thereof.

10. The method of claim 6 wherein each of said network nodes has a transmit power associated therewith, and wherein said step of modifying said set of network links comprises adding one or more links thereto by increasing the transmit power associated with one or more of said network nodes.

11. An apparatus for reducing end-to-end delays in a multi-hop wireless network, the apparatus comprising a processor adapted to:
calculate, based on an initial physical network topology and on a set of parameters representing current traffic conditions in said multi-hop wireless network, a value of a metric which positively correlates to said end-to-end delays; and
modify said initial physical network topology to generate a modified physical network topology which results in a reduced value of said metric when said metric is calculated based on said modified physical network topology and on said set of parameters representing current traffic conditions in said multi-hop wireless network.

12. The apparatus of claim 11 wherein said initial physical network topology comprises a set of network nodes and a set of network links interconnecting pairs of said network nodes.

13. The apparatus of claim 12 wherein said set of parameters representing current traffic conditions comprise queue lengths associated with said network links.

14. The apparatus of claim 3 wherein said metric is computed based on an eigenvalue of a matrix M, wherein said matrix M is a stochastic transition probability matrix derived based on said queue lengths associated with said network links.

15. The apparatus of claim 14 wherein said eigenvalue of said matrix M is a second largest eigenvalue of said matrix M.

16. The apparatus of claim 12 wherein said modifying said initial physical network topology to generate a modified physical network topology comprises modifying said set of network links by adding links thereto and/or removing links therefrom.

17. The apparatus of claim 16 wherein one or more of said network nodes are non-static network nodes, and wherein said modifying said set of network links comprises moving one or more of said non-static network nodes in physical relation to one or more other network nodes, thereby modifying said set of network links as a result of changed distances therebetween.

18. The apparatus of claim 17 wherein said moving of said one or more non-static nodes is constrained so as to limit said changed distances therebetween to a minimum value and to prevent said network from becoming disconnected.

19. The apparatus of claim 16 wherein said modifying said set of network links comprises adding one or more nodes to said set of network nodes and adding one or more network links connected to said one or more added nodes to said set of network links as a result thereof.

20. The apparatus of claim 16 wherein each of said network nodes has a transmit power associated therewith, and wherein said modifying said set of network links comprises adding one or more links thereto by increasing the transmit power associated with one or more of said network nodes.
